(19) United States
(12) Patent Application Publication
(10) Pub. No.: US 2014/0129269 A1
(43) Pub. Date: May 8, 2014

(54) Forecasting Business Entity Characteristics Based on Planning Infrastructure

(71) Applicant: SAP AG, Walldorf (DE)

(72) Inventors: Michael Rey, Walldorf (DE); Hagen Grabenhorst, Walldorf (DE); Saskia Kurz, Walldorf (DE); San Tran, Walldorf (DE)

(73) Assignee: SAP AG, Walldorf (DE)

(21) Appl. No.: 13/667,216

(22) Filed: Nov. 2, 2012

(51) Int. Cl. G06Q 10/06

(52) U.S. Cl. 705/7.12

(57) ABSTRACT

A planning infrastructure in an enterprise supports planning using characteristics of business entities and key figures collected from the activities of the business entities. The planning may incorporate predictions made on characteristics of the business entities that operate with the enterprise. The predicted characteristics may be stored in the enterprise's master data for those business entities, thus linking the planning results with the business entities.

### BACKGROUND

Unless otherwise indicated herein, the approaches described in this section are not prior art to the claims in this application and are not admitted to be prior art by inclusion in this section.

Planning is an integral part of the management cycle in a business enterprise. Large companies are typically situated in complex environments (e.g., competitive landscape, political situation, geographical location, etc.). Different companies may follow different business models in order to accomplish their missions. Depending on the overall company mission, a business enterprise must consider the environmental situation in which it operates. The management cycle helps the enterprise to position itself in the complex environment in which it operates to keep on track in reaching its overall goals.

The company mission is the framework to which various operations in the company are tasked to contribute. For example, planning support coordinates different divisions toward a common goal and defines general conditions for operations in the enterprise. Execution planning involves steps necessary for the actual value creation of the company. Reporting tracks all transactions incurred by the execution processes. Analysis focuses on calculating the success of objectives achieved and seeks out the reasons for any deviations. The result of the analysis is measured against the company mission and leads to an evaluation of overall goals and actions to be taken in order to steer the course of the planning effort.

Business planning covers different levels. Strategic planning is typically concerned with determining the direction of an enterprise's future development; for example, the range of products and services, return on investment, company growth, and so on. Strategic planning is a simulative process, where different scenarios are modeled and then evaluated to calculate the expected value creation. Strategy evaluation leads to setting targets for the operational units, which means breaking down the high-level strategic goals to targets on the execution level (for example, expected net revenue, sales growth rate, and so on).

Operational planning typically includes allocating the resources (labor, capital, assets, etc.) necessary to fulfill the targets, and reconciling the resources across operational units. For example, sales volume has to be reconciled with production volume; e.g., if you have production capacity to produce 200 bottles of sunscreen per month and you can sell 1000 bottles in August, you must produce at least 800 bottles of sunscreen in the months prior to August. The results of the operational planning process may be used for detailed planning and scheduling in execution planning.

### BRIEF DESCRIPTION OF THE DRAWINGS

FIG. 1 shows an illustrative high level diagram of an enterprise configured in accordance with the present disclosure.

FIG. 1A illustrates a more specific embodiment of FIG. 1.

FIG. 2 shows a process flow for planning in accordance with the present disclosure.

FIGS. 3A-3E illustrate a specific example of predicting a characteristic of a business entity.

FIG. 4 illustrates a high level block diagram of a computer system according to the present disclosure.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

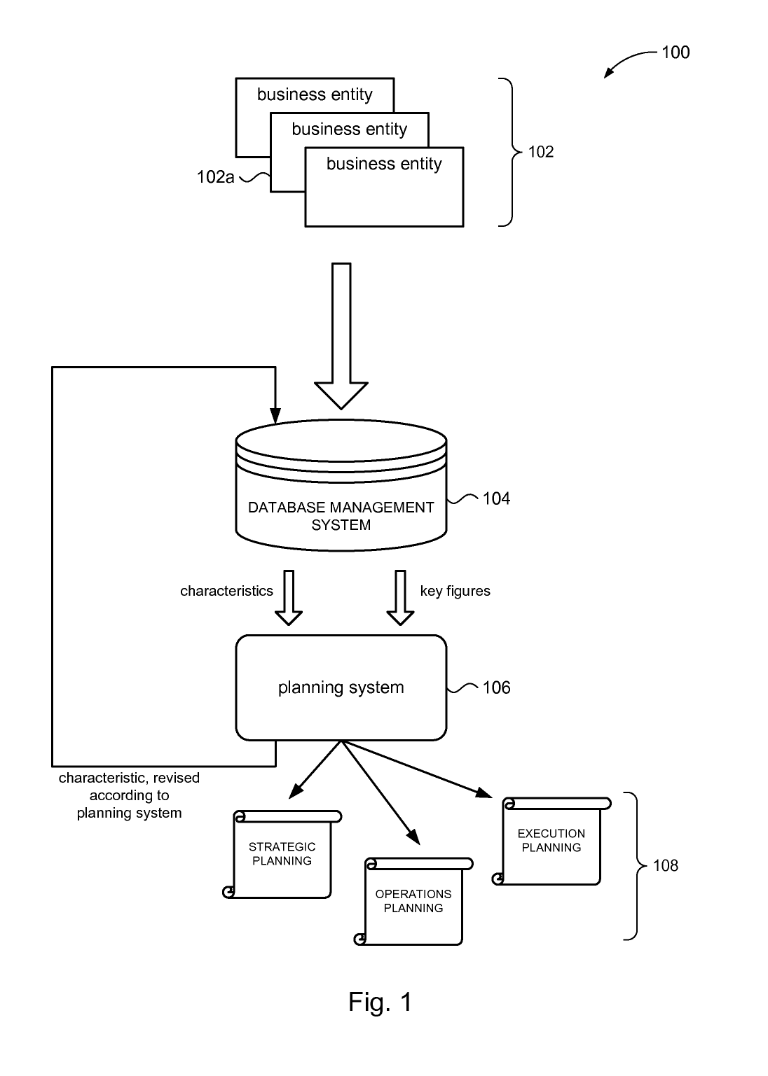

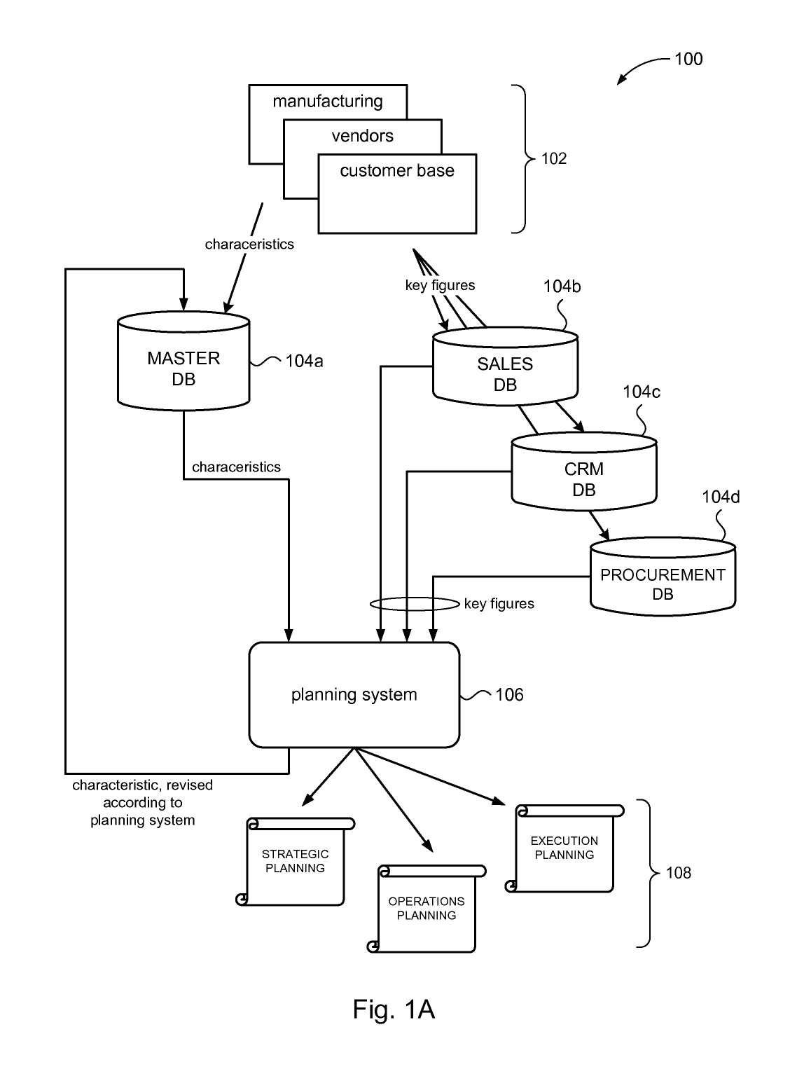

FIG. 1 illustrates an enterprise 100 organized in accordance with embodiments of the present disclosure. The enterprise 100 may be any organization for conducting business; e.g., manufacturer of goods, service provider (e.g., hospitals, financial, travel, etc.), government agency, and so on.

In some embodiments, as shown in FIG. 1, the enterprise 100 may comprise several business entities 102. As used herein, “business entity” may refer to individuals, groups, organizations, etc. that operate within the enterprise 100 and outside of the enterprise. Business entities 102 may refer to operations within the enterprise 100 at all levels of the enterprise; e.g., human resources department, marketing groups, product development groups, a sales organization in the enterprise, products or services provided by the enterprise, and so on. Business entities 102 may refer to organizations external to the enterprise 100 that nonetheless interact with the enterprise; e.g., vendors (suppliers) who provide raw material, supplies, information, and the like that are consumed by the enterprise 100. Business entities 102 may refer to customers of the enterprise 100 who purchase goods or services produced by the enterprise. And so on.

The enterprise 100 may further comprise a database management system (DBMS or database system) 104. The DBMS 104 may serve as the data repository for the enterprise 100. In some embodiments, the DBMS 104 may include a data warehouse and associated functionality. The DBMS 104 may support data processing functionality, such as for example, on line transaction processing (OLTP) and online analytical processing (OLAP). As will be explained in more detail below, the DBMS 104 may receive and store data relating to the business entities 102, including characteristics of the business entities and key figures of production and/or consumption resulting from activities of the business entities.

The enterprise 100 may further comprise a planning system(s) 106. The planning system 106 may provide planning functionality for the enterprise, including for example strategic planning functionality to provide the enterprise with long term goals and strategies in accordance with the enterprise's vision and mission. The planning system 106 may support operational planning to plan for various business entities 102 such as sales planning, supply planning, cost center planning, procurement planning, and so on. The bridge between strategic planning and operational planning may include modeling tools to forecast customer demands, resource allocation, production quotas, and so on. The planning system 106 may facilitate execution planning functionality to provide detailed planning such as material requirements planning (MRP), shop flow control, product planning, capacity planning, contract handling, and so on.

In some embodiments, the planning system 106 may comprise a planning framework. Typical business intelligence (BI) systems can provide an integrated planning framework that can create process-oriented planning. The SAP Business ByDesign® platform, for example, is a business intelligence platform that includes the Lean Analytics™ planning infrastructure. The DBMS 104 may provide its data to the planning system 106, such as characteristics and key figures for one or more business entities 102 for example. The planning system 106 may model or otherwise compute on key figures to make predictions or projections of expected behavior or performance of one or more of the business entities 102. Various plans 108 such as strategic planning, operations planning, and execution planning, may then be developed based on the predicted performance of the enterprise's business entities 102.

In accordance with principles of the present disclosure, the planning system 106 may make predictions on the characteristics for a given business entity 102a in order to enhance the predictions or projections of expected behavior or performance of the business entity to improve making strategic decisions and planning operational behaviour. Further in accordance with the present disclosure, the planning system 106 may update the DBMS 104 with the predicted characteristics for the business entity 102a in order to link the business entity to the planning results 108.

Merely as an illustrative example, FIG. 1A shows some additional details of the elements of enterprise 100 shown in FIG. 1. For example, typical business entities 102 of enterprise 100 may include various manufacturing divisions, several vendors, numerous customers, and so on. In some embodiments, the DBMS 104 may comprise several databases, such as for example, a mater database 104a and various operational databases (e.g., sales DB 104b, customer relations management (CRM) DB 104c, procurement DB 104d, and so on).

The master DB 104a may store the enterprise's “master data”. Master data typically refers to data that remains unchanged over a long period of time. Master data may comprise information that is needed again and again, in the same way, by other operations in the enterprise 100. Master data may include characteristics of the enterprise's business entities 102. The “characteristics” of a business entity refer to information that describe the attributes or qualities of the business entity. Characteristics for a business entity typically refer to information such as who is the business entity, what does the business entity supply to the enterprise 100 or buys from the enterprise, when, where, and how does the business entity interact with the enterprise, and so on. For example, the characteristics of a business entity such as a supplier of raw material to the enterprise 100 may include descriptive information such as the name of the supplier (e.g., John Smith, the ABC Steel Company, etc.), the address of the supplier, information about the raw materials that the supplier supplies to the enterprise, supplier billing details, an internal supplier ID number, and so on. Characteristics may refer to attributes such as the supplier's ranking among the enterprise's other suppliers for the same raw material; e.g., supplier XYZ is the fifth largest supplier among the enterprise's suppliers. As another example, a business entity such as a customer may have characteristics such as birth date, sex, age, categories of goods that the customer has purchased, and so on.

The operational databases 104b-104d may store operational data relating to activities performed by the business entities 102. The operational data may be maintained in a single database or, as illustrated in FIG. 1A, may be stored in several databases. The operational data typically comprise “key figures” of the business entities 102. The key figures of a business entity refer to quantitative (numerical) measures of production and/or consumption resulting from activities of the business entity. Key figures typically refer to information such as amount, weight, volume, and other measures that relate to the business entity's production and/or consumption activity. For example, if the business entity is a supplier, the key figures may be the monthly amounts of material that the enterprise 100 purchases from the supplier, the supplier's delivery turnaround times, rejection rates, and so on. As another example, if the business entity is a manufacturing line in a factory, the key figures may include monthly output of units produced by the manufacturing line, number of defective units in the production, consumption rates of raw materials, and so forth. If the business entity is a customer, the key figures may be how much the customer spends per month, how many units of an item they purchase, and so on.

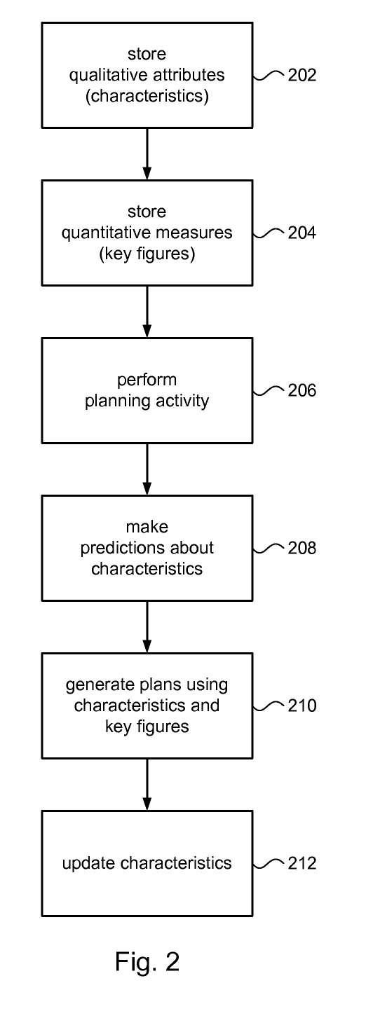

In accordance with the present disclosure, the enterprise 100 may conduct planning activity using that data that the enterprise collects on its business entities 102. In some embodiments, the planning activity may proceed according to the process flow shown in FIG. 2. At 202, qualitative attributes and other descriptive information (collectively referred to as characteristics) of a business entity comprising the enterprise 100 (e.g., business entity 102a, FIG. 1) may be stored in the DBMS 104. In some embodiments, for example, such information may be stored as master data in a master database (e.g., 104a, FIG. 1A).

At 204, quantitative measures and other numerical data (collectively referred to as key figures) of the business entity may be stored in the DBMS 104. Such information may be collected during the course of operations performed by the business entity. For example, the enterprise 100 may collect data when order for supplies are placed with a supplier and when the those orders are fulfilled. Data may be collected from manufacturing lines as units are produced and inventoried. Data may be collected when sales orders are received and fulfilled. And so on.

At 206, various operational groups in the enterprise 100 may perform planning activities. For example, executive-level managers may conduct strategic planning activities to define or refine the enterprise's strategic goals. Operational managers may perform operations planning to develop operational plans to meet those strategic goals. The planning activity typically requires an understanding of the state of the enterprise 100, which may be reflected in the characteristics and key figures of the business entities 102 in the enterprise. Accordingly, the planning activity may include receiving such data from the DBMS 104, for example, in the form of database queries, data models, and the like.

Based on the state of the enterprise 100, the planning activity may then make projections about when, where, and how the various business entities 102 of the enterprise will behave going forward. Accordingly, the planning activity may include modeling the behaviour of a business entity (e.g., by computing statistics, running simulations, and so on) using the characteristics and key figures for the business entity. For example, a customer's future purchasing activity may be based on their previous purchase amounts (key figures) and when, during the year, that the purchases were made, such as seasonal purchasing (characteristics).

In accordance with principles of the present disclosure, at 208, the planning activity may include predicting new values for one or more characteristics of a business entity. At 210, plans may be generated from the analyses performed at 206 and 208. At 212, the DBMS 104 may be updated with any predicted characteristics that were made at 208 for any given business entity. These aspects of the present disclosure will now be discussed in terms of a specific illustrative example.

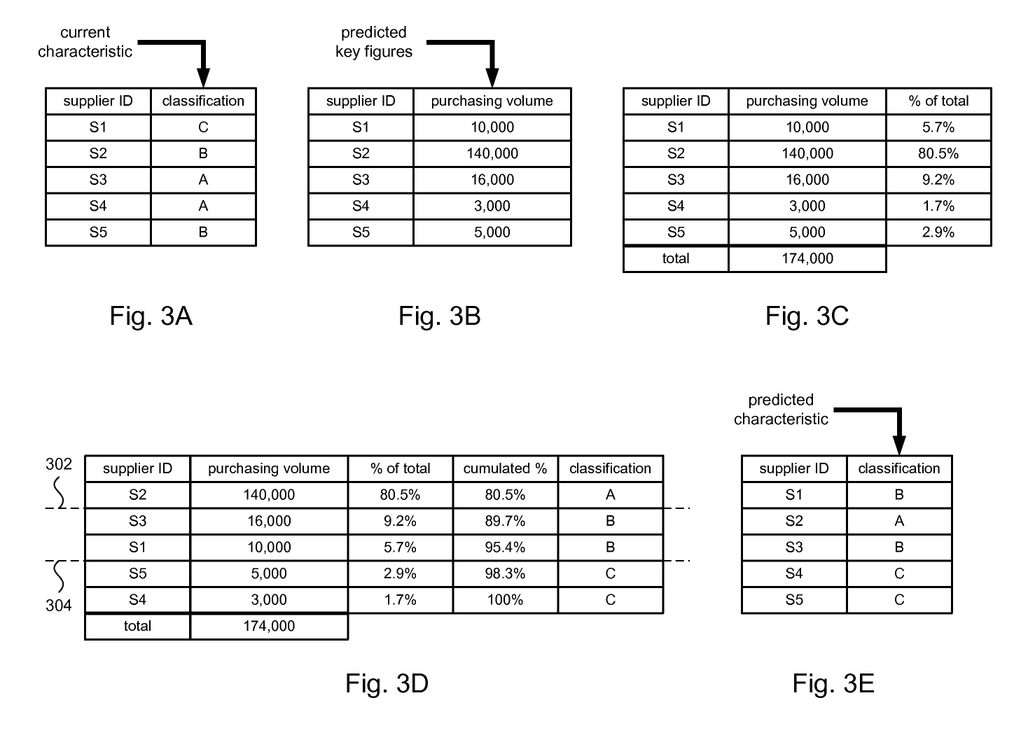

FIGS. 3A-3E illustrate a specific example of a characteristic that may be updated in accordance with principles of the present disclosure. The example merely serves to illustrate how a characteristic may be predicted and then used for planning. It will be appreciated that planning may be performed on other characteristics as well. In this example, the characteristic of interest relates to an ABC classification system that can be used to rank certain business entities. In particular, the characteristic is a specific category of the ABC classification system that a given business entity is classified in.

ABC classification is a ranking system for identifying and grouping related items in terms of their value to the enterprise (e.g., 100). The system groups items into three categories: A, for “very” important; B, for “moderately” important; and C, for “less” important. A typical criterion for defining the boundaries between categories is the 80/15/5 rule. Accordingly, items that belong to category A account for 80% of an effect (e.g., cost, revenue, inventory, etc.), items in category B would account for 15% of the effect, and category C items account for 5%. It will be appreciated that other ABC classifications may be defined using more categories or fewer categories, and/or with different boundaries between categories.

Typically, ABC classification groups related items. For example, business entities 102 in the enterprise 100 who are vendors may be deemed to be related items. Customers of the enterprise 100 may constitute another group of related items. And so on. Different groups of related items may be classified with different ABC classifications. Merely as an example, for instance, the enterprise 100 may classify its vendors using an ABC classification that defines three categories and 80/15/5 boundaries. However, the customers of enterprise 100 may be classified using an ABC classification that defines five categories (e.g., A through E), and the boundaries may be 40/30/15/10/5.

The goal of ABC classification is to provide a way for the enterprise 100 to identify the very important items (category A) so that the enterprise may control those items most closely. Once the A category items, B category items, and C category items have been identified, each category can be handled in a different way, with more attention being devoted to items in category A, less attention to B, and even less to C. ABC classification is often associated with inventory control, but the system can also be used to rank things such as which customers are most important, which business activities cause the most financial risk, which employees are most valuable or which parts of a process are most likely to cause a bottleneck, and so on.

The example shown in FIGS. 3A-3E classifies those business entities 102 of the enterprise 100 who are suppliers to the enterprise. FIG. 3A shows a list of suppliers S1-S5. Each supplier is associated with various characteristics, such as for example, an ID number (e.g., S1, S2, etc.), an address, and so on. The characteristic of interest used in the example illustrated in FIGS. 3A-3E is the supplier's classification (category) in an ABC classification system that defines three categories and an 80/15/5 boundary configuration. FIG. 3A represents the initial values for each supplier's classification, as currently stored in the DBMS 104 for example. Thus, for example, supplier S1 is currently a class C supplier, supplier S2 is currently a class B supplier, and so on. The planning system 106 may use the supplier classification in its planning activities. For example, the planning system 106 may develop a comprehensive management plan for the enterprise's class A suppliers; e.g., to improve relationships with those suppliers. A less comprehensive plan may be produced for the enterprise's class B suppliers, and less so with its class C suppliers.

As explained above, the enterprise 100 may collect key figures for each supplier during the course of doing business with the supplier over time. For example, the volume of each purchase (e.g., 2 tons of steel) placed with a supplier may be recorded as a key figure. The cost of the purchase may be recorded as another key figure, delivery time may be another key figure, and so on. FIGS. 3A-3E show the use of a key figure called “purchasing volume.”

FIGS. 3B-3E illustrate how a characteristic, namely the ABC classification characteristic, for a business entity may be predicted, for example, by planning system 106. As the example shown in FIGS. 3A-3E illustrates, the key figure called purchasing volume may be used to determine a supplier's classification in the ABC classification system. FIG. 3B, shows that the planning system 106 may compute or otherwise arrive at a predicted purchasing volume for each supplier. For example, the predicted value of purchasing volume for supplier S1 may be computed based on the volumes of previous purchases made with S1. The predicted value may be determined based on other key figures of S1, and more generally the predicted value may be based on any other information relating to S1 or to the goods or services provided by S1. A predicted purchasing volume may be computed for each supplier S1-S5.

In FIG. 3C, each supplier's predicted purchasing volume may be expressed as a percentage of the total predicted purchasing volume. For example, for supplier S1, its predicted purchasing volume of 10,000 (e.g., 10,000 widgets) may be expressed as a percentage of the total predicted purchasing volume, namely 5.7%.

In FIG. 3D, the suppliers may be sorted according to their percentage-of-total values. The 80/15/5 boundaries for the ABC classification may be applied to the percentages. In an embodiment, the 80/15/5 boundaries may be expressed in terms of cumulated percentage of purchasing volume. Thus, category A suppliers represent 80% of the total predicted purchasing volume, category A and B suppliers represent 95% of the total predicted purchasing volume, and category A, B, and C suppliers represent 100% of the predicted purchasing volume.

Accordingly, the table in FIG. 3D may include a “cumulated percentage” column that shows a running total of the percentage of predicted purchasing volume of the suppliers. For example, supplier S2 constitutes 80.5% of the total predicted purchasing volume, supplier S2 and S3 together constitute 89.7% of the total predicted purchasing volume, and so on. The “A” class may be identified by drawing a line at the 80% accumulation level. The “B” class may be identified by drawing a line at the 95% accumulation level, and the “C” class automatically falls out. It will be appreciated that exact boundaries at 80% and 95% are not likely to occur when actual numbers are used. The boundaries may need to be approximated. Accordingly, FIG. 3D shows lines 302 and 304, drawn respectively at the 80.5% and 89.7% boundary and at the 95.4% and 98.3% boundary, thus identifying the three categories.

FIG. 3E shows the final result after re-classifying the suppliers based on their predicted purchasing volume key figure. Thus, the classification characteristic for supplier S1 has changed from C to B, supplier S2 has changed from B to A, and so on for the remaining suppliers. The predicted values for the classification may then be used to update their currently stored values in the DBMS 104. The predicted values for the classification characteristic may be used to provide planning that is forward looking. For example, these results may inform the planning system 106 to shift the focus of attention from suppliers S3 and S4 (who were previously class A suppliers) to supplier 2, who is now predicted to be the only class A supplier going forward.

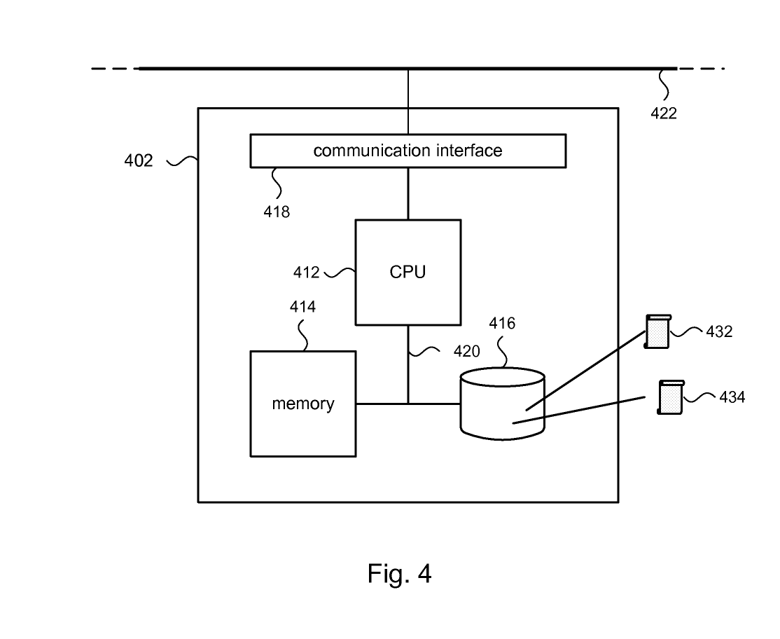

FIG. 4 illustrates a high level block diagram of a computer system 402 configured and programmed to operate as planning system 106 in accordance with the present disclosure. The computer system 402 may include a central processing unit (CPU) 412 or other similar data processing component. The CPU 412 may be a single processor or a multiprocessor subsystem. The computer system 402 may include various memory components. For example, the memory components may include a volatile memory 414 (e.g., random access memory, RAM) and a data storage device 416. A communication interface 418 may be provided to allow the computer system 402 to communicate over a communication network 422, such as a local area network (LAN), the Internet, and so on. An internal bus 420 may interconnect the components comprising the computer system 402.

The data storage device 416 may comprise a non-transitory computer readable medium having stored thereon computer executable program code 432. The computer executable program code 432 may be executed by the CPU 412 to cause the CPU to perform steps of the present disclosure, for example the steps set forth in FIG. 2, for example, to perform planning on a characteristic for a business entity. The data storage device 416 may store data structures 434 such as object instance data, runtime objects, and any other data described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. It will be appreciated that embodiments are not limited to any specific combination of hardware and software. Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A method in an enterprise comprising operating a computer system in the enterprise to perform steps of:
storing, in a database system, data for characteristics that are associated with a business entity of the enterprise, the characteristics representative of descriptive attributes of the business entity;
storing, in the database system, data for key figures that are associated with the business entity, the key figures representative of quantitative measures of production or consumption by the business entity resulting from operations of the business entity;
generating a predicted data value for at least a first characteristic that is associated with the business entity based on one or more of the key figures of the business entity; and
replacing in the database system a data value for the first characteristic with the predicted data value.

2. The method of claim 1 further comprising performing one or more planning functions for the enterprise using one or more of the characteristics and key figures that are associated with the business entity, including the predicted data value for at least the first characteristic.

3. The method of claim 1 further comprising performing one or more planning functions for the enterprise, including performing computations on some of the key figures of the business entity, wherein the predicted data value for at least the first characteristic is based on results of the computations performed.

4. The method of claim 3 further comprising generating one or more business plans for the enterprise based on the computations performed and on the predicted data value for at least the first characteristic that is associated with the business entity.

5. The method of claim 3 wherein the business entity is characterized by an ABC classification system, wherein the first characteristic represents a category in the ABC classification system that the business entity is assigned to, wherein the predicted data value for the first characteristic is a new category for the business entity that is predicted based at least on the results of the computations performed.

6. The method of claim 1 further comprising performing computations on the one or more key figures of the business entity, wherein the predicted data value for at least the first characteristic that is associated with the business entity is based on the computations performed.

7. The method of claim 6 wherein performing computations includes computing a predicted data value for at least one key figure of the business entity, wherein the predicted data value for at least the first characteristic that is associated with the business entity is based on the predicted data values for at least the one key figure.

8. The method of claim 1 wherein the business entity is characterized by an ABC classification system, wherein the first characteristic represents a category in the ABC classification system that the business entity is assigned to, wherein the predicted data value for the first characteristic is a new category for the business entity that is predicted based at least on the one or more of the key figures of the business entity.

9. The method of claim 1 wherein the database system comprises master data and transaction data, wherein the characteristics that are associated with a business entity are stored among the master data in the database system, wherein the key figures that are associated with the business entity are stored among the transaction data in the database system.

10. A computer system comprising:
a computing device;
a database system; and
a data storage device having stored thereon computer executable program code, which, when executed by the computing device, causes the computing device to:
store, in the database system, data for characteristics that are associated with a business entity of the enterprise, the characteristics representative of descriptive attributes of the business entity;
store, in the database system, data for key figures that are associated with the business entity, the key figures representative of quantitative measures of production or consumption by the business entity resulting from operations of the business entity;
generate a predicted data value for at least a first characteristic that is associated with the business entity based on one or more of the key figures of the business entity; and
replace in the database system a data value for the first characteristic with the predicted data value.

11. The computer system of claim 10 wherein the computer executable program code, which, when executed by the computing device, further causes the computing device to perform one or more planning functions for the enterprise using one or more of the characteristics and key figures that are associated with the business entity, including the predicted data value for at least the first characteristic.

12. The computer system of claim 10 wherein the computer executable program code, which, when executed by the computing device, further causes the computing device to perform one or more planning functions for the enterprise, including performing computations on some of the key figures of the business entity, wherein the predicted data value for at least the first characteristic is based on results of the computations performed.

13. The computer system of claim 12 wherein the computer executable program code, which, when executed by the computing device, further causes the computing device to generate one or more business plans for the enterprise based on the computations performed and on the predicted data value for at least the first characteristic that is associated with the business entity.

14. The computer system of claim 12 wherein the business entity is characterized by an ABC classification system, wherein the first characteristic represents a category in the ABC classification system that the business entity is assigned to, wherein the predicted data value for the first characteristic is a new category for the business entity that is predicted based at least on the results of the computations performed.

15. The computer system of claim 10 wherein the computer executable program code, which, when executed by the computing device, further causes the computing device to perform computations on the one or more key figures of the business entity, wherein the predicted data value for at least the first characteristic that is associated with the business entity is based on the computations performed.

16. The computer system of claim 15 wherein the computations include computing a predicted data value for at least one key figure of the business entity, wherein the predicted data value for at least the first characteristic that is associated with the business entity is based on the predicted data values for at least the one key figure.

17. A non-transitory computer readable storage medium having stored thereon computer executable program code, which, when executed by a computer, causes the computer to perform steps of:
storing, in a database system, data for characteristics that are associated with a business entity of the enterprise, the characteristics representative of descriptive attributes of the business entity;
storing, in the database system, data for key figures that are associated with the business entity, the key figures representative of quantitative measures of production or consumption by the business entity resulting from operations of the business entity;
generating a predicted data value for at least a first characteristic that is associated with the business entity based on one or more of the key figures of the business entity; and
replacing in the database system a data value for the first characteristic with the predicted data value.

18. The non-transitory computer readable storage medium of claim 17 wherein the computer executable program code, which, when executed by a computer, further causes the computer to perform a step of performing one or more planning functions for the enterprise using one or more of the characteristics and key figures that are associated with the business entity, including the predicted data value for at least the first characteristic.

19. The non-transitory computer readable storage medium of claim 17 wherein the computer executable program code, which, when executed by a computer, further causes the computer to perform a step of performing one or more planning functions for the enterprise, including performing computations on some of the key figures of the business entity, wherein the predicted data value for at least the first characteristic is based on results of the computations performed.

20. The non-transitory computer readable storage medium of claim 17 wherein the computer executable program code, which, when executed by a computer, further causes the computer to perform a step of performing computations on the one or more key figures of the business entity, wherein the predicted data value for at least the first characteristic that is associated with the business entity is based on the computations performed.
